(19) United States
(12) Patent Application Publication
(10) Pub. No.: US 2006/0250567 A1
(43) Pub. Date: Nov. 9, 2006

(54) FLAT DISPLAY MODULE

(76) Inventors: Chuan-Pei Yu, I-Lan Hsien (TW); Ming Chuan Chou, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,493

(22) Filed: Sep. 13, 2005

(30) Foreign Application Priority Data
May 6, 2005 (TW) 094114704

(51) Int. Cl. C09K 19/02

(52) U.S. Cl. 349/181

(57) ABSTRACT

A polarizing device contains a transparent plate and a birefringent material spread within the transparent plate. The birefringent material converts natural light propagating in the transparent plate into a first linearly polarized light and a second linearly polarized light, where the first and second linearly polarized lights are refracted toward different directions by the birefringent materials.

### BACKGROUND OF THE INVENTION

1. Field of the Invention

The invention relates to flat display module, and more particularly, to flat display module with a single polarizer.

2. Description of the Prior Art

With the rapid development of technology, various kinds of intelligent informational products are available to people living in modern societies. For example, flat display modules, such as liquid crystal display modules, etc., have played quite an important role in informational products. Since a liquid crystal display (LCD) has the advantages of lightweight, low energy consumption, and free of radiation emission, the LCD is extensively applied in portable informational products, such as notebooks, personal digital assistants (PDAs), and cellular phones, etc. There is even a trend of gradually replacing the cathode ray tube (CRT) monitor of conventional personal computers and CRT TVs with flat display modules.

Generally, a liquid crystal display module (LCM) is a key of the LCD, comprising an LCD panel and a back light module. The LCD panel is a liquid crystal molecular layer positioned in between two glass substrates. Each glass substrate is usually coated with an alignment layer for making the liquid crystal molecules align along a specific and parallel direction of a surface of the glass substrate. Transistors, electrodes, and other electrical devices on the glass substrate provide an electric field to the liquid crystal molecules that can be twisted by the magnitude of the electric field. The birefringent of the liquid crystal molecules can be changed by the direction of the liquid crystal molecules so that the direction of polarized light passing through the liquid crystal molecules is changed. Therefore, the display principle of the liquid crystal display panel is that polarizers are positioned on top and bottom surfaces of the liquid crystal display panel and the twist of the liquid crystal molecules is utilized to control the quantity of light exiting the panel to show images.

Please refer to FIG. 1 that is schematic diagram of display principles of a liquid crystal display panel according to prior art. The liquid crystal display panel includes two glass substrates 12 having electrodes, and liquid crystal molecules 14 positioned between the two glass substrates 12. A first polarizer 16 and a second polarizer 18 are perpendicularly positioned with respect to each other's polarization on two sides of the glass substrates 12. In the top-figure, no electric field is being applied and the natural light produced by a light source passes through the first polarizer 16 to form a linearly polarized light P″, and then the linearly polarized light “P” passes through the glass substrates 12 and a liquid crystal molecule layer 14. It is noted that the liquid crystal molecule layer 14 has enough thickness to convert the linearly polarized light “P” 90 degrees into a linearly polarized light “S” for passage through the second polarizer 18. On the other hand, exerting voltage can change the twist of the liquid crystal molecule layer 14 as is shown in the bottom-figure. For example, the twist of the liquid crystal molecule layer 14 parallels the electric field so that the linearly polarized light “P” passes through the liquid crystal molecule layer 14 without changing its polarization direction, resulting in not through the second polarizer 18. As above-mentioned, the natural light is converted into linearly polarized light by the polarizer, and the linearly polarized light is converted into elliptically polarized light by exerting different electric field strengths to the liquid crystal molecules so that a gray image can be showed, so it is necessary that polarizers are positioned on two sides of the liquid crystal display plane in the LCM.

However, the function of general polarizer allows specific directionally polarized light to pass through the polarizer, but absorbs light having polarizations perpendicular to the specific direction, meaning 50% of improperly polarized light is absorbed and causes a low utility rate of light. At the same time, the polarizers positioned on two sides of the liquid crystal display plane limit the size of the LCM so that the thickness of the LCM cannot decrease. Therefore, there are many problems that could be improved upon, such as the design of the LCM, the utility rate of light of the LCM, and the thickness of the LCM.

### SUMMARY OF THE INVENTION

It is therefore a primary objective of the claimed invention to provides a flat display module having a polarizing device to solve the above-mentioned problems.

According to the claimed invention, the polarizing device includes a transparent plate having a light-incidence plane and a light-exiting plane, where natural light is capable of passing through the light-incidence plane into the transparent plate, and a birefringent material spread within the transparent plate. The birefringent material is capable of converting natural light propagating in the transparent plate into two perpendicular linearly polarized lights, and of scattering the two perpendicular linearly polarized lights with different refraction angles.

Furthermore according to the claimed invention, the flat display module includes a backlight unit, a flat display panel positioned above the backlight unit, and a polarizer positioned on the display plane of the flat display panel. The backlight unit includes a transparent plate having a bottom surface and a top surface, the bottom surface having a plurality of diffusing patterns thereon for scattering light, and a light generator positioned at a side of the transparent plate for generating natural light that passes into the transparent plate. In addition, the backlight unit furthermore includes a plurality of birefringent particles distributed in the transparent plate, and the birefringent particles have a birefringence (double refraction, DR), air gap, or a material having one or more optical axes. The birefrigent particles are capable of converting natural light into two perpendicular linearly polarized lights, and of scattering the two perpendicular linearly polarized lights with different refraction angles.

According to the claimed invention, a method of fabricating a flat display module provides a transparent plate including a light-exiting plane at a top surface of the transparent plate, and a plurality of diffusing patterns disposed on a bottom surface of the transparent plate. The transparent plate further includes a plurality of birefringent particles distributed therein and the birefringent particles are capable of converting light propagating in the transparent plate into two perpendicular linearly polarized lights. By adjusting the arrangement of angles and shapes of the birefringent particles in the transparent plate, the refracted two perpendicular linearly polarized lights can be made to propagate toward the light-exiting plane and a side surface or the bottom surface of the transparent plate respectively. Furthermore, by adjusting the shapes and the distribution densities of the diffusing patterns and the birefringent particles in the transparent plate, uniformed light leaves the transparent plate through the light-exiting plane. In addition, the method provides a flat display panel positioned above the light-exiting plane of the transparent plate, and a polarizer disposed on the display plane.

The present invention's polarizing device utilizes a birefringent material spread within the transparent plate so that the natural light is converted into two perpendicular linearly polarized lights P and S. The linearly polarized lights P and S are scattered in different directions, so that only linearly polarized light P or linearly polarized light S is scattered out of the polarizing device and then into the flat display plane. The invention can replace a conventional first polarizer deposited under the flat display plane, and decrease the thickness and cost of the flat display plane.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is schematic diagram of display principles of a liquid crystal display plane according to prior art.

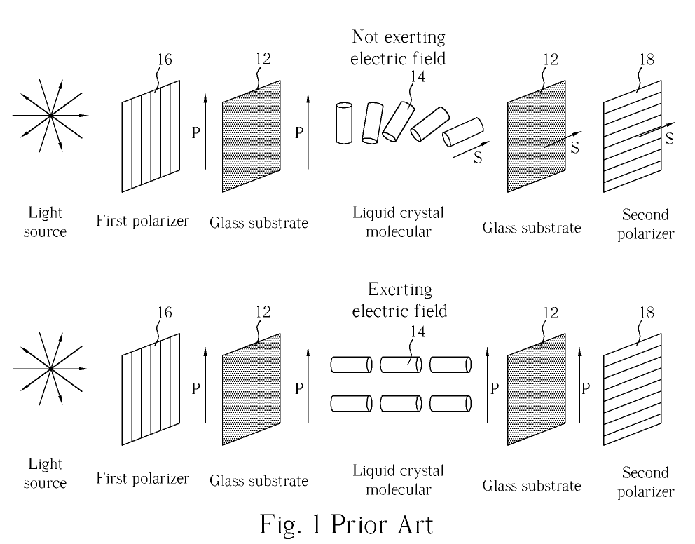

FIG. 2 is a cross-sectional view of the flat display module according to a first embodiment of the present invention.

FIG. 3 is a magnified diagram of a part of the flat display module shown in FIG. 2.

FIG. 4 is a cross-sectional view of the flat display module according to a second embodiment of the present invention.

FIG. 5 is a cross-sectional view of the flat display module according to a third embodiment of the present invention.

FIG. 6 is a cross-sectional view of the flat display module according to a fourth embodiment of the present invention.

### DETAILED DESCRIPTION

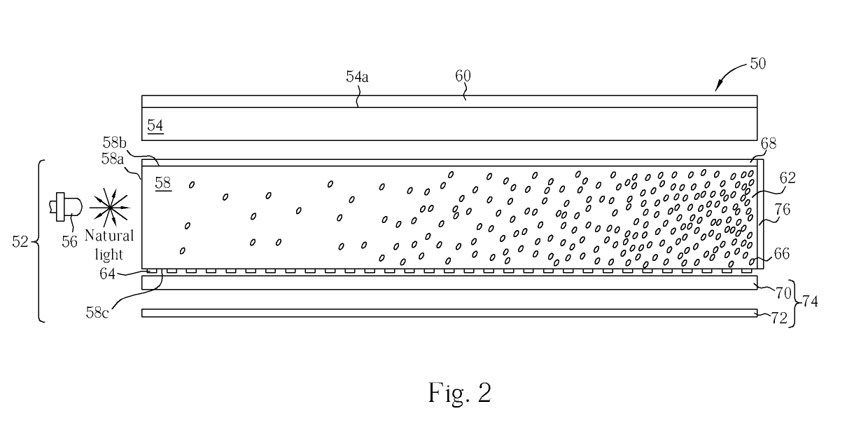

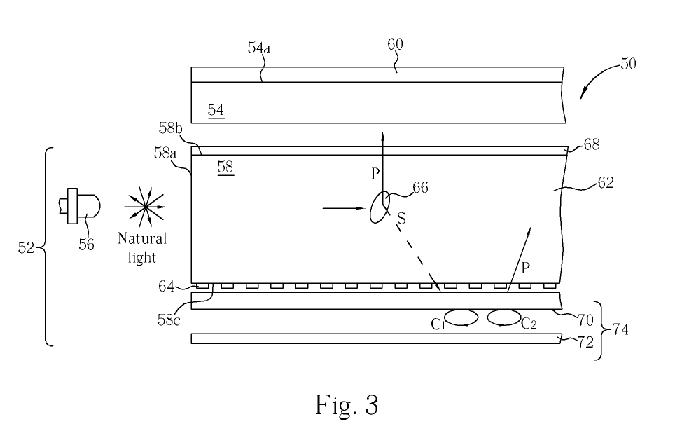

Please refer to FIG. 2 and FIG. 3. FIG. 2 is a cross-sectional view of a flat display module 50 according to a first embodiment of the present invention, and FIG. 3 is a magnified diagram of a part of the flat display module 50 shown in FIG. 2. The flat display module 50 is a liquid crystal display module (LCM) that includes a back light module 52, and a liquid crystal display plane 54 having a display plane 54a and positioned above the back light module 52. In addition, the flat display module 50 has only one polarizer 60 positioned above the display plane 54a of the liquid crystal display module 54.

The back light module 52 includes a light generator 56 and a polarizing device 62, and the light generator 56 is positioned at a side of the polarizing device 62, for generating natural light into the polarizing device 62. The polarizing device 62 includes a transparent plate 58 having a light-incidence plane 58a and a light-exiting plane 58b. The light-incidence plane 58a is nearer the light generator 56, for receiving the natural light generated by the light generator 56, and the light-exiting plane 58b is a top surface of the transparent plate 58, for allowing scattered light in the transparent plate 58 to pass through the light-exiting plane 58b into the liquid crystal display plane 54. Furthermore, the function of the transparent plate 58 is for guiding the paths of scattering light and uniforming scattering light in the transparent plate 58. The material of the transparent plate 58 can be a light guide acryl, or other light guide materials, such as a plastic material, polymethylmethacrylate (PMMA), polycarbonate (PC), ZEONOR®, and ARTON®, and can be made by injection-molding. A plurality of diffusing patterns 64 (preferably protruding dot patterns) is positioned on a bottom surface 58c of the transparent plate 58, for breaking total reflecting light into scattering light, and changing the route of light to enhance the uniformitivity of the liquid crystal display plane 54.

The polarizing device 62 further includes a birefringent material 66 spreading in the transparent plate 58. In the embodiment, the birefringent material 66 is a plurality of birefringent particles distributed in the transparent plate 58, and the birefringent particles have a birefringence (double refraction, DR) and are capable of converting natural light into two perpendicularly linearly polarized lights, such as a linearly polarized light P and a linearly polarized light S, and of scattering the two perpendicular linearly polarized light with different refraction angles. As shown in FIG. 3, when the natural light passes through the light-incidence plane 58a into the transparent plate 58 and contacts the birefringent material 66, the birefringent material 66 converts the natural light into the linearly polarized light P (shown as the solid line) and the linearly polarized light S (shown as the dotted line) which polarizes perpendicular to the linearly polarized light P, and scatters the two perpendicular linearly polarized lights P and S with different refraction angles. In this embodiment, any material that has the above-mentioned features can be applied in the present invention as the birefringent material 66 in the transparent plate 58, such as quartz and liquid crystal material. Generally, the material having an air gap or one or more optic axes can be the birefringent material 66 in the present invention.

It is noted that adjusting the arrangement of angles, positions, and shapes of the birefringent particles in the transparent plate 58 can control refraction angles of linearly polarized light P and S to scatter the linearly polarized light P toward the light-incidence plane 58b and the linearly polarized light S toward the bottom surface 58c of the transparent plate 58, meaning the birefringent material 66 converts natural light into two perpendicular linearly polarized lights so that the linearly polarized light P always passes throughout the light-incidence plane 58b. In this design, a polarizer does not need to be positioned between the liquid crystal display panel 54 and backlight module 52, but linearly polarized light P scattered by the transparent plate 58 is directly utilized to coordinate with the polarizer 60 positioned above the liquid crystal display panel 54 to display image. In addition, for achieving the purpose of the above-mentioned and having better diffusion routing of light in the polarizing device 62, the distribution densities of the birefrigent material 66 in the transparent plate may not be uniform. As shown in FIG. 2, the distribution density of the birefringent material 66 closer to the light-incidence plane 58a is less than the distribution density of the birefringent material 66 farther from the light-incidence plane 58a in the transparent plate 58, to control the routes of light. According to the present invention, the birefringent particles of the birefringent material 66 in different places of the transparent plate 58 may have different arranging angles, or the shapes of birefringent particles are selectively changed to adjust the refracted paths of the linearly polarized lights P and S. Moreover, utilizing the optic axis or the air gaps of the birefringent particles can effectively separate the linearly polarized lights P and S.

The polarizing device 62 of the present invention further includes a polarization conversion mechanism 74 having a quarter wave plate 70 and a bottom reflector 72 positioned at the bottom surface 58c of the transparent plate 58 respectively. As shown in FIG. 3, the linearly polarized light S scatted by the birefringent material 66 toward the bottom surface 58c of the transparent plate 58 passes through the quarter wave plate 70 and converts into a circularly polarized light C₁, and then the circularly polarized light C₁ passes into the reflector 72 and is rebounded by the bottom reflector 72 to form a circularly polarized light C₂ whose rotational direction is opposite to the circularly polarized light's C₁. The circularly polarized light C₂ passes through the quarter wave plate 70 and converts into the linearly polarized light P to pass through the light-exiting plane 58b into the liquid crystal display plane 54. Therefore, the linearly polarized light S separated by the birefringent material 66 can be converted into the linearly polarized light P by the polarization conversion mechanism 74, and the linearly polarized light P is re-used to enhance the whole brightness of the flat display module 50.

In order to improve brightness and utility rate of light, the back light module 52 of the present invention can selectively include a plurality of side reflectors 76 positioned on the surface of the transparent plate 58 except at the light-incidence plane 58a and the light-exiting plane 58b, and can selectively comprise at least an optic film 68 on the polarizing device 62. The optic film 68 can be a prism or a diffusion film.

Therefore, as above-mentioned, the method of fabricating a flat display module 50 according to the present invention comprises:

Step 1: providing a transparent plate 58, a plurality of diffusion patterns 64 disposed on a bottom surface 58c of the transparent plate 58, and the transparent plate 58 comprising a plurality of birefringent particles 66 formed with birefringent material distributed therein and the birefringent particles being capable of converting light propagating in the transparent plate 58 into two perpendicular linearly polarized lights P and S.

Step 2: adjusting the arrangement of angles and shapes, optic axis, and/or air gap of the birefringent particles in the transparent plate to make the refracted linearly polarized lights P and s propagating toward the light-exiting plane 58b and a side surface or the bottom surface 58c of the transparent plate 58 respectively.

Step 3: adjusting the distribution densities of the diffusing patterns 64 and the birefringent particles such that properly polarized light leaves the transparent plate 58 uniformly through the light-exiting plane 58b.

Step 4: providing a flat display panel 54 positioned above the light-exiting plane 58b of the transparent plate 58 and having a display plane 54a.

Step 5: providing a polarizer 60 disposed on the display plane 54a.

The polarizing device 62 is the combination of the transparent plate 58, birefringent material 66, and diffusion patterns 64. A method of disposing the birefringent particles formed with birefringent material 66 into the transparent plate 58 is by doping, drawing, or pouring the birefringent particles into the materials of the transparent plate 58. Also, the method of the present invention further comprises positioning a polarization conversion mechanism 74 under the transparent plate 58, and the polarization conversion mechanism 74 has a quarter wave plate 70 and a bottom reflector 72 for improving the utility rate of light.

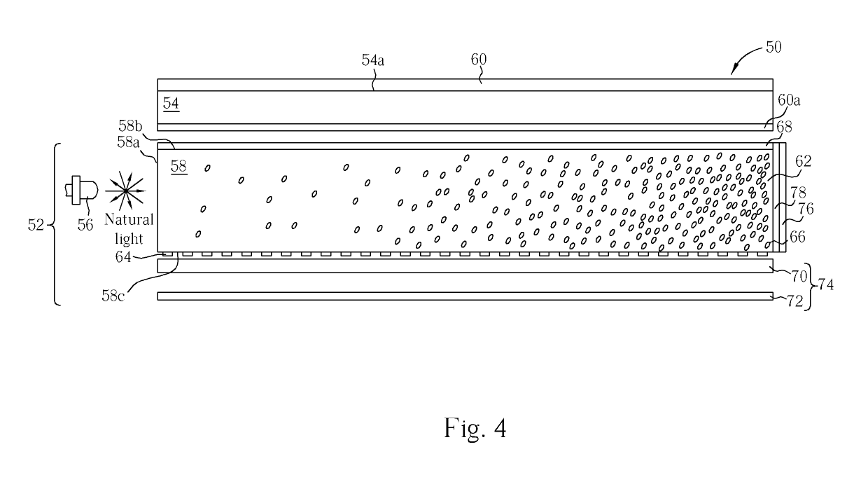

FIG. 4 is a cross-sectional view of the flat display module 50 according to second embodiment of the present invention. For convenient illustration in FIG. 4, similar components retain the same label numbers that were used in FIG. 2. In this second embodiment, the bottom surface of the liquid crystal display plane 54 has a bottom polarizer 60a for filtering light generated by the back light module 52 for allowing the linearly polarized light P to pass through the bottom polarizer 60a but absorbing the linearly polarized light S. Therefore, the bottom polarizer 60a can ensure that only the linearly polarized light P passes into the liquid crystal display panel 54 while blocking the linearly polarized light S so that the liquid crystal display plane 54 has the best image. The linearly polarized light S refracted from the birefringent material 66 to the bottom surface 58c passes through the quarter wave plate 70 and is rebounded by the bottom reflection layer 72, and then passes through the quarter wave plate 70 again to convert to linearly polarized light P that can be transmitted to the liquid crystal display plane 54.

In addition, in this embodiment, a side of the polarizing device 62 further has a quarter wave plate 78 positioned between the transparent plate 58 and the side reflection layer 76. When the light is refracted by the birefringent material 66, most linearly polarized light P directly enters into liquid crystal display plane 54, but the linearly polarized light S is converted to linearly polarized light P by the quarter wave plate 78 and the side reflection layer 76 on the side of the polarizing device 62 to improve the utility rate of light.

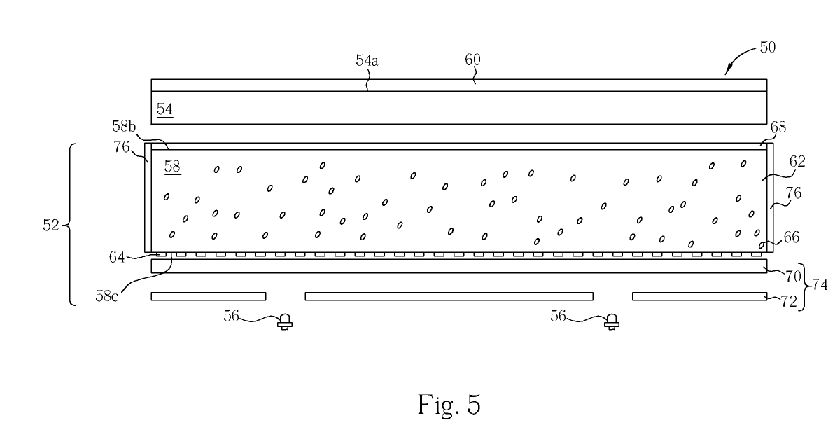

The method of fabricating the polarizing device is not limited to application in edge-type backlight modules, but also is applicable to a direct-type backlight module by changing the location of the light generator to the bottom of polarizing device as shown in FIG. 5, which is a cross-sectional view of the flat display module 50 according to a third embodiment of the present invention. For convenient illustration in FIG. 5, similar components retain the same label numbers that were used in FIG. 2. In this embodiment, the flat display module 50 has a direct-type light source as shown in FIG. 5. A plurality of light generators 56 are positioned under the polarization conversion mechanism 74, and the bottom reflection layer 72 includes a plurality of openings corresponding to the light generators 56 for letting the light from the light generators 56 enter into the polarizing device 62.

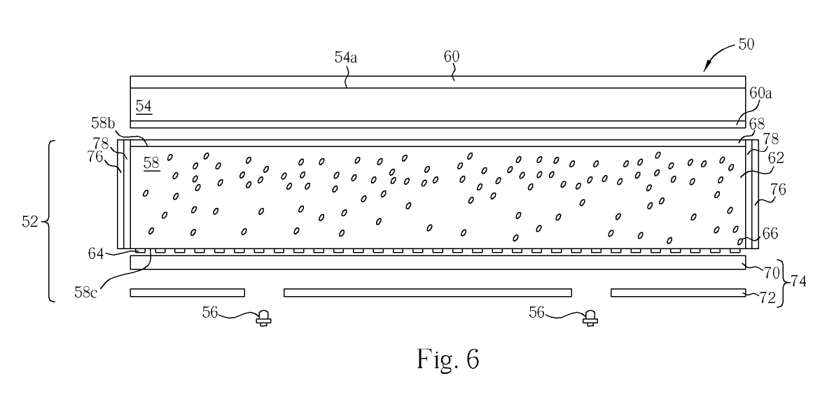

Shown in FIG. 6 is a cross-sectional view of the flat display module 50 according to a fourth embodiment of the present invention. In this embodiment, the light generator 56 is positioned under the polarizing device 62 to form a direct-type backlight module. The bottom surface of the liquid crystal display plane includes a bottom polarizer 60a for filtering light to allow linearly polarized light P to pass through the bottom polarizer 60a but absorbing linearly polarized light S. Accordingly, the bottom polarizer 60a can further ensure that only the linearly polarized light P generated from the backlight module 52 passes into the liquid crystal display plane 54 while preventing linearly polarized light S so that the liquid crystal display plane 54 has the best image. In this embodiment, at least a polarization conversion mechanism can be selectively positioned on a side of the polarizing device 62, which means the quarter wave plate 78 can be deposited between the side reflection layer 76 and the transparent plate 58 to change the linearly polarized light S propagating to a side of the polarizing device 62 into linearly polarized light P to improve the utility rate of light.

Compared to prior art, the present invention provides a polarizing device in the back light module, and the polarizing device includes a birefringent material that can convert the natural light into two perpendicular linearly polarized lights and scatter the two perpendicular linearly polarized lights with different refraction angles. The present invention utilizes the polarizing device to substitute for a conventional polarizer in the flat display module that can effectively decrease the thickness and cost of the flat display module. Also, by adjusting the arrangement of angles and shapes of the birefringent material in the polarizing device and diffusing patterns of the bottom of the polarizing device can control the whole brightness and uniformity of the flat display module and improve the utility rate of the light.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polarizing device, the polarizing device comprising:
a transparent plate having a light-incidence plane and a light-exiting plane, wherein natural light is capable of passing through the light-incidence plane into the transparent plate; and
a birefringent material spread in the transparent plate, the birefringent material being capable of converting natural light propagating in the transparent plate into a first linearly polarized light and a second linearly polarized light polarized perpendicularly to the first linearly polarized light, and capable of scattering the perpendicular first and second linearly polarized lights with different refraction angles.

2. The polarizing device of claim 1, wherein the polarizing device further comprises a plurality of diffusing patterns positioned on a plane opposite to the light-exiting plane for scattering natural light, the first linearly polarized light, and the second linearly polarized light.

3. The polarizing device of claim 2, wherein the diffusing patterns are a plurality of protruding dot patterns.

4. The polarizing device of claim 2, wherein the refraction angles of the first linearly polarized light enable the first linearly polarized light to leave the transparent plate through the light-exiting plane, and the refraction angles of the second linearly polarized light enable the second linearly polarized light to propagate toward the plane opposite to the light-exiting plane.

5. The polarizing device of claim 1, wherein a material of the transparent plate has a light guide function.

6. The polarizing device of claim 5, wherein the material of the transparent plate is a plastic material.

7. The polarizing device of claim 6, wherein the material of the transparent plate is selected from the group consisting of polymethylmethacrylate (PMMA), polycarbonate (PC), ZEONOR®, and ARTON®.

8. The polarizing device of claim 1, wherein shapes and distribution densities of the birefringent material in the transparent plate are not uniform.

9. The polarizing device of claim 8, wherein the distribution density of the birefringent material closer to the light-incidence plane is less than the distribution density of the birefringent material farther from the light-incidence plane in the transparent plate.

10. The polarizing device of claim 1, wherein the polarizing device further comprises a polarization conversion mechanism positioned on a surface of a plane opposite to the light-exiting plane or positioned on at least a side plane of the polarizing device, where the polarization conversion mechanism is capable of reflecting the second linearly polarized light and converting the second linearly polarized light into the first linearly polarized light polarized perpendicularly to the second linearly polarized light.

11. The polarizing device of claim 10, wherein the polarization conversion mechanism comprises:
a quarter wave (λ/4) plate positioned on a surface of the diffusing patterns; and
a reflector positioned on a surface of the quarter wave plate.

12. The polarizing device of claim 1, wherein the light-exiting plane is positioned at a top surface of the transparent plate, and the light-incidence plane is positioned at a side surface of the transparent plate.

13. The polarizing device of claim 1, wherein the light-exiting plane is positioned at a top surface of the transparent plate, and the light-incidence plane is positioned at a bottom surface of the transparent plate.

14. The polarizing device of claim 1, wherein the polarizing device is applied to a back light unit of a flat display module.

15. The polarizing device of claim 14, wherein the flat display module is a liquid crystal display module (LCM).

16. The polarizing device of claim 15, wherein the LCM only has a first polarizer.

17. The polarizing device of claim 15, wherein the LCM comprises a first polarizer and a second polarizer positioned on a top surface and a bottom surface of the LCM respectively.

18. The polarizing device of claim 1, wherein the birefringent material is selected from the group consisting of quartz and liquid crystal material.

19. The polarizing device of claim 1, wherein the birefringent material is selected from the group consisting of a material having a birefringence, a material having air gaps, and a material having one or more optic axes.

20. A flat display module, the flat display module comprising: a back light unit, comprising:
a transparent plate having a bottom surface and a top surface, the bottom surface having a plurality of diffusing patterns thereon for scattering light;
a light generator positioned at a side of the transparent plate or below the bottom surface of the transparent plate for generating natural light that passes into the transparent plate; and
a plurality of birefringent particles distributed in the transparent plate, the birefringent particles having a birefringence (double refraction, DR) and being capable of converting natural light into a first linearly polarized light and a second linearly polarized light which polarizes perpendicularly to the first linearly polarized light, and capable of scattering the perpendicular first linearly polarized light and second linearly polarized light with different refraction angles;
a flat display panel positioned above the back light unit, a top surface of the flat display panel serving as a display plane; and
a first polarizer positioned on the display plane of the flat display panel.

21. The flat display module of claim 20, wherein the refraction angles of the first linearly polarized light enable the first linearly polarized light to pass through the top surface of the transparent plate to leave the transparent plate, and the refraction angles of the second linearly polarized light enable the second linearly polarized light to propagate toward the bottom surface of the transparent plate.

22. The flat display module of claim 20, wherein a material of the transparent plate has a light guide function that guides fraction directions of natural light so that natural light is scattered uniformly in the transparent plate.

23. The flat display module of claim 22, wherein a material of the transparent plate is a plastic material.

24. The flat display module of claim 23, wherein the material of the transparent plate is selected from the group consisting of PMMA, PC, ZEONOR®, and ARTON®.

25. The flat display module of claim 20, wherein the diffusing patterns are a plurality of protruding dot patterns.

26. The flat display module of claim 20, wherein shapes and distribution densities of the birefringent particles in the transparent plate are not uniform.

27. The flat display module of claim 26, wherein the distribution density of the birefringent particles closer to the light generator is less than the distribution density of the birefringent particles farther from the light generator in the transparent plate.

28. The flat display module of claim 20, wherein the back light unit further comprises at least a polarization conversion mechanism positioned at the bottom surface of the transparent plate, and the polarization conversion mechanism is capable of reflecting the second linearly polarized light resulting in a half wave (λ/2) difference so as to convert the reflected second linearly polarized light into the first linearly polarized light.

29. The flat display module of claim 28, wherein the polarization conversion mechanism comprises a quarter wave (λ/4) plate and a reflector positioned on the bottom surface of the transparent plate in order.

30. The flat display module of claim 29, wherein the back light unit comprises at least two of the polarization conversion mechanisms positioned on the bottom surface and at least a side surface of the transparent plate.

31. The flat display module of claim 28, wherein the light generator is positioned below the transparent plate and the polarization conversion mechanism.

32. The flat display module of claim 20, wherein the back light unit further comprises at least an optical film positioned on the top surface of the transparent plate.

33. The flat display module of claim 20, wherein materials of the birefringent particles are selected from the group consisting of quartz and liquid crystal material.

34. The flat display module of claim 20, wherein the materials of the birefringent particles are selected from the group consisting of a material having birefringence, a material having air gaps, and a material having one or more optic axes.

35. The flat display module of claim 20, wherein the flat display module further comprises a second polarizer positioned at the bottom surface of the flat display panel.

36. A method of fabricating a flat display module, the method comprising:
providing a transparent plate, which comprises a light-exiting plane at a top surface of the transparent plate, and a plurality of diffusing patterns disposed on a bottom surface of the transparent plate, the transparent plate further comprising a plurality of birefringent particles distributed therein where the birefringent particles are capable of converting light propagating in the transparent plate into a first linearly polarized light and a second linearly polarized light polarized perpendicularly to the first linearly polarized light;
adjusting the arrangement of angles and shapes of the birefringent particles in the transparent plate to enable the refracted first linearly polarized light to propagate toward the light-exiting plane and enable the refracted second linearly polarized light to propagate toward a side surface or the bottom surface of the transparent plate respectively;
adjusting the distribution densities of the diffusing patterns and the birefringent particles in the transparent plate to uniform light that leaves from the transparent plate through the light-exiting plane;
providing a flat display panel positioned above the light-exiting plane of the transparent plate, wherein the top surface of the flat display panel serves as a display plane; and
providing a polarizer disposed on the display plane.

37. The method of claim 36, wherein the method further comprises providing at least a polarization conversion mechanism positioned on the bottom surface of the transparent plate.

38. The method of claim 37, wherein the polarization conversion mechanism comprises a quarter wave plate and a reflector positioned at the bottom surface of the transparent plate in order.

39. The method of claim 38, wherein the method provides two of the polarization conversion mechanisms disposed at the bottom surface and at least a side surface of the transparent plate respectively.

40. The method of claim 37, further comprising providing at least a light generator positioned below the polarization conversion mechanism.

41. The method of claim 36, further comprising providing at least a light generator positioned at a side of the transparent plate.

42. The method of claim 36, wherein the step of adjusting the distribution densities of the birefringent particles in the transparent plate comprises making the distribution density of the birefringent particles closer to the light generator less than the distribution density of the birefringent particles farther from the light generator.

43. The method of claim 36, wherein the flat display panel is a liquid crystal display panel.

44. The method of claim 36, wherein the material of the transparent plate has a light guide function.

45. The method of claim 44, wherein the material of the transparent plate is a plastic material.

46. The method of claim 45, wherein the material of the transparent plate is selected from the group consisting of PMMA, PC, ZEONOR®, and ARTON®.

47. The method of claim 36, wherein the diffusing patterns are a plurality of protruding dot patterns.

48. The method of claim 36, wherein the method further comprises providing at least an optical prism positioned on the top surface of the transparent plate.

49. The method of claim 36, wherein materials of the birefringent particles are quartz or liquid crystal materials.

50. The method of claim 36, wherein the materials of the birefringent particles are selected from the group consisting of a material having birefringence, a material having air gaps, and a material having one or more optic axes.

51. The method of claim 36, wherein the method further comprises a step of disposing the birefringent particles into the transparent plate by means of doping, drawing, or pouring the birefringent particles into the materials of the transparent plate.

52. The method of claim 36, wherein the method further comprises providing a second polarizer positioned at a bottom surface of the flat display panel.
